(19) United States
(12) Patent Application Publication
(10) Pub. No.: US 2010/0127971 A1
(43) Pub. Date: May 27, 2010

(54) Methods of rendering graphical images

(75) Inventor: Thomas Ellenby, San Francisco, CA (US)

Correspondence Address: Thomas Ellenby;GeoVector Corp., 601 MINNESOTA STREET, # 212, SAN FRANCISCO, CA, 94107, US

(73) Assignee: GeoVector Corp.

(21) Appl. No.: 12/592,239

(22) Filed: Nov. 21, 2009

Related U.S. Application Data
(60) Provisional application No. 61/199,922, filed on Nov. 21, 2008.

(51) Int. Cl. G09G 5/00

(52) U.S. Cl. 345/156

(57) ABSTRACT

Methods for defining the complexity and priority of graphics rendering in mobile devices based upon various physical states and factors related to the mobile system including those measured and sensed by the mobile device, such as position, pointing direction and vibration rate, are disclosed and described. In particular, a handheld computing system having an image type user interface includes graphical images generated in response to the instantaneous position and orientation of the handheld device to improve the value of the presented image and overall speed of the system.

### REFERENCE TO RELATED APPLICATION

This application is a new filing without dependence from earlier filed non-provisional applications. This application does claim benefit and priority from U.S. Provisional application filed Nov. 21, 2008 having Ser. No. 61/199,922, by British inventor Thomas Ellenby of San Francisco, Calif.

### BACKGROUND OF THE INVENTION

1. Field

The following invention disclosure is generally concerned with computer generated graphical images rendered with dependence on the physical state of a coupled mobile device.

2. Prior Art

Computer systems today are often used to generate highly dynamic images in response to user requests. A user of a computerized device specifies parameters of interest—for example by way of an interactive user interface, to indicate a desire for more information or specifically more information of a certain type. Many are familiar with the fantastic computer application known as “Google Earth” which provides images (mixed photographic and computer generated) in response to highly specified parameters from a user viewer. In example, should one wish to learn of good locations for scuba diving, one might only click the checkbox of an appropriate user interface to cause a redraw of a map where the level of detail of the map is adjusted such that it includes markers associated with previously recorded good scuba diving locations. The level of detail of a map type graphical image is said to be responsive to a user's specification of various parameters.

Military systems have long been provided to respond to preferred targets within a detected field of regard. Certain radar systems, such as the Phalanx anti-missile system developed by General Dynamics, classify incoming targets by considering factors such as change in target bearing. Targets that having constant bearing and closing range are then classified as to their range and speed of approach. Targets that could reach the ship soonest are classified as “most important” and are addressed with priority.

Of course, most all of these techniques first show up in the world of computer gaming which tends to lead all other fields with new tricks and technique with regard to graphics rendering. In one important invention, methods of “real-time geometry”, were developed by Dr. Alexander Migdal of MetaTools Inc. of Carpenteria Calif. Real-time geometry modifies the detail of a graphic object as a function of the apparent distance from a viewer of the image. For example, a race car in a computer game gains almost lifelike detail as it roars toward the game player at the foreground of a compound image, but loses resolution as it falls further back into the background of a similar scene.

Each of these systems however is restricted in its ability to render images in view of an instantaneous state of surrounding environment and status of a device associated with the scene. Devices of the art do not consider dynamic parameters of a mobile device in their image rendering schemes. However, it would be of considerable value to provide computer generated graphical images dynamic with respect to the physical states of a system associated with the scene being rendered—for example a mobile device on which the images are being displayed. Particularly, the position and orientation of the mobile device may suggest preferences to an image rendering system whereby the level of detail of images rendered is affected by specific values which correspond to position and attitude (orientation).

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, Thomas Ellenby with inventions of methods of rendering graphical images including methods of prioritizing detail in response to the physical states of a mobile device associated with an environment being represented.

It is a primary function of this [ . . . ] to provide [ . . . ]. It is a contrast to prior art methods and devices that systems first presented here do not [ . . . ]. A fundamental difference between [ . . . ] of the instant invention and those of the art can be found when considering its [ . . . ].

[Summary here]

The concept of ‘importance’ or ‘priority’ as used to control graphics rendering described herein differs from systems common in the art in that the sensed states of a mobile device associated with the scene being represented by a graphical image, for example the position and pointing direction or attitude of a mobile system, as determined by device subsystems, are taken into account in a classification of each graphical object's importance. Additionally, methods for generating Usage Profiles based upon a particular users habits and desires, that is used to modify an importance factor of selected graphical elements, is disclosed and described herein. Additionally methods of reducing complexity, and in some special cases omission of graphical elements based upon their importance factor is disclosed. Additionally, limits with regard to the complexity of graphical objects to be generated based upon the sensed conditions of a device, e.g. the position and/or pointing direction of a mobile system associated with a scene being rendered, are disclosed.

Methods for defining and controlling graphics complexity and prioritizing order of graphics rendering or generation by augmented reality and other mobile devices with known performance characteristics based upon various sensed conditions of a mobile device and other inputs. These methods would be of utility in, among others, the fields of air, sea and land navigation, gaming and tourism (augmented reality and otherwise), local search, sports viewing, etc. Increasingly mobile devices are incorporating sensors such as GPS, compasses and accelerometers for various uses such as map display and game playing. By using sensed physical conditions of a device such as position, pointing direction, rate of change of position, slew rate, vibration rate, etc., methods of the invention will enable a mobile device to display the most important graphics first, or give them priority in generation, and will also enable the mobile device to display graphics at complexity levels that are appropriate to those sensed conditions.

### OBJECTIVES OF THE INVENTION

It is a primary object of the invention to provide methods for rendering graphics in response to the physical states of an associated device.

It is an object of the invention to provide mobile systems responsive to geometric nature of the device

It is a further object to provide computer graphics rendering with selective and variable detail.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a block diagram of a preferred embodiment of the invention showing a vision system with related subsystems and sensors;

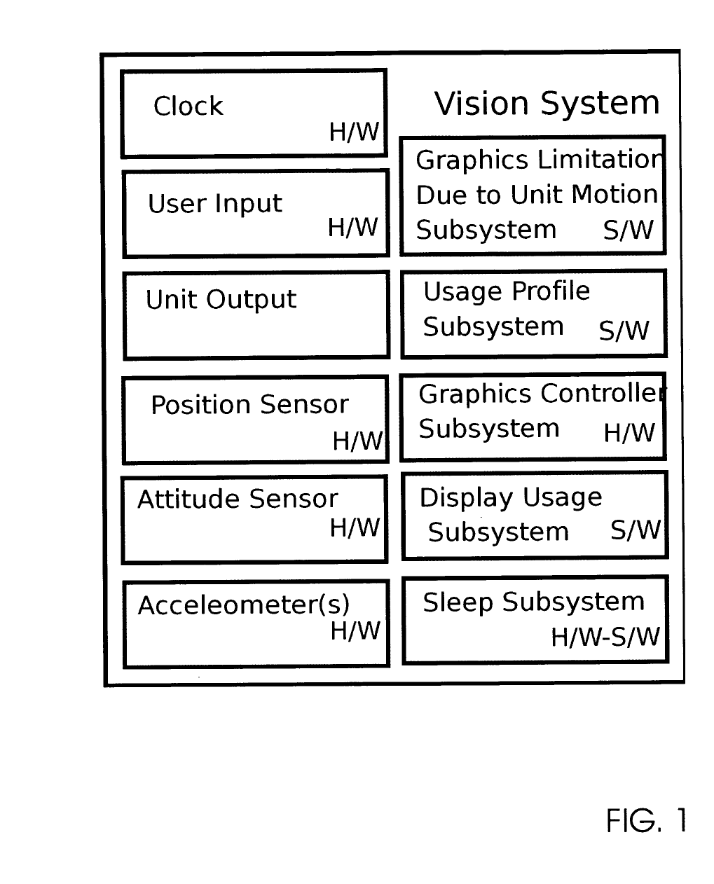

FIG. 2 is a flow chart showing the general operation of the system described

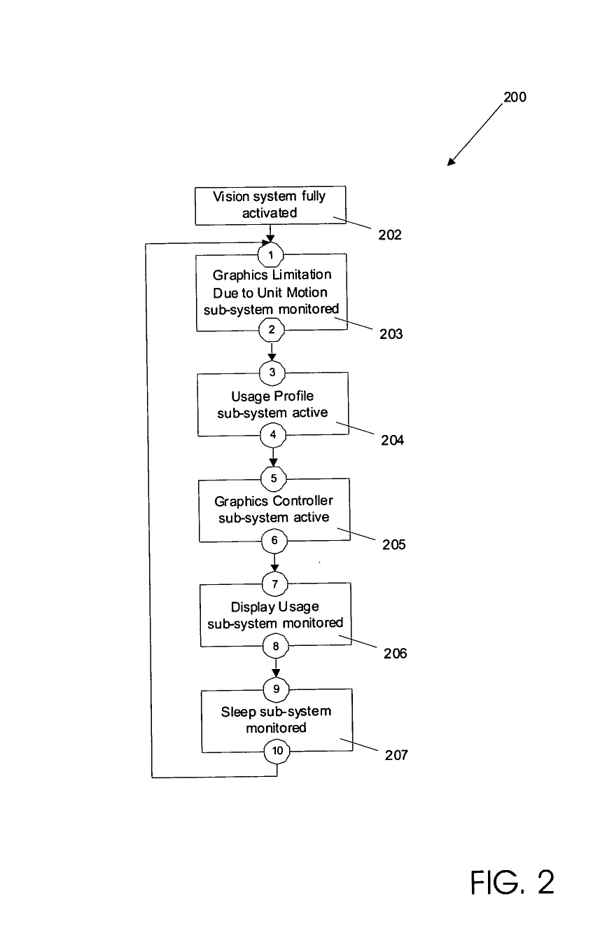

FIG. 3 is a flow chart showing the operation of the Graphics Limitation Due to Unit Motion Subsystem, part 1;

FIG. 4 is a flow chart showing the operation of the Graphics Limitation Due to Unit Motion Subsystem, part 2;

FIG. 5 is a flow chart showing the operation of the Usage Profile Subsystem, part 1;

FIG. 6 is a flow chart showing the operation of the Usage Profile Subsystem, part 2A;

FIG. 7 is a flow chart showing the operation of the Usage Profile Subsystem, part 2B;

FIG. 8 is a flow chart showing the operation of the Usage Profile Subsystem, part 2C;

FIG. 9 is a flow chart showing the operation of the Usage Profile Subsystem, part 2D;

FIG. 10 is a flow chart showing the operation of the Usage Profile Subsystem, part 2E;

FIG. 11 is a flow chart showing the operation of the Usage Profile Subsystem, part 2F;

FIG. 12 is a flow chart showing the operation of the Graphics Controller Subsystem, part 1;

FIG. 13 is a flow chart showing the operation of the Graphics Controller Subsystem, part 2 Graphics Hierachy;

FIG. 14 is a flow chart showing the operation of the Display Usage Subsystem;

FIG. 15 is a flow chart showing the operation of the Sleep Subsystem;

FIG. 16 is a diagram illustrating the creation of areas of interest;

FIG. 17 is a diagram illustrating the area of interest and field of view/address of a mobile device;

FIG. 18 is a flow chart showing the operation of the Snapshot Mode, part 1; and

FIG. 19 is a flow chart showing the operation of the Snapshot Mode, part 2.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Mobile Device

By ‘mobile device’ it is meant any device having a position, location and orientation which may vary or be varied by a user—in example a hand held computing device.

### Importance

‘Importance’ or ‘Importance Factor’ refers to a value which is associated with various graphical elements. The importance factor controls an order and detail level of graphics to be rendered.

### Graphical Object

A ‘graphical object’, ‘graphic’, or ‘graphics’ are used to refer to any portion subset of an entire image system which may be comprised of a plurality of elements.

### PREFERRED EMBODIMENTS OF THE INVENTION

To render computer graphics, a certain processing power is required depending upon the complexity of a graphical element being rendered. Very simple geometries and colors may be used to represent a certain object in the real world. The White House might be represented as a simple white polygon in a very simple representation (graphical object). Alternatively, a very highly detailed image of 16 million colors and complex shading and lighting effects might be used as a graphical object to represent the White House.

Systems taught here associate a complexity factor or ‘complexity number’ to graphics which may be rendered to represent real objects. Some considerations as to how a complexity number may be generated include those of the following list.

### Complexity Number (CN):

The complexity of a graphic, and therefore its related Complexity Number (CN), to be generated by a mobile device may be modified by the system based upon various conditions such as;
Position of the device relative to the geo-located position of the graphic, i.e. range from the device to the position of the graphic.
Bearing of the device relative to the geo-located bearing from the device of the graphic.
Slew rate of the device.
Vibration of the device.
Rate of change of position of the device.
Rate of change of bearing of an object associated with a graphic relative to a device.
Threat level of an object associated with graphic, i.e. don't generate a detailed image of a high tension cable and instead make the graphic a glowing, bright red, area 10 times wider than the actual object.
User defined limitation of graphics for all or some classes of objects.
Software/application defined limitation of graphics for all or some classes of objects.
Limiting graphics complexity to reduce power consumption. E.g. the device is low on power so generate lower res graphics to save on processing time and hence power consumption.
Limit graphics complexity to be downloaded, if on a wireless link, if data transmission speed or throughput is low.
User defined graphics levels for classes of objects. E.G. show the SF Giants at a higher level of complexity than the Dodgers. Note that the user could define maximum or minimum CN's for classes of objects.
Areas of interest. If an object is in a pre-defined area of interest then CN is altered. The change to the CN could be plus or minus.
Probable or actual latency of wireless or other data links or mediums.
Positioning error, e.g. if the GPS has determined that it has an error of +/−100 m set graphics of specific classes, navigation markers for example, to lowest CN and increase size of graphic by a defined percentage.

In any given image, various graphical elements may be more important than certain others. To each graphical element, an importance factor or importance number is associated.

### Importance Number (IN):

Additionally the priority for generation of a specific graphic to be generated by a device, i.e. its level of “importance” and therefore its related Importance Number (IN), may modified by the system based upon various conditions such as;
Software/application defined importance.
User defined order of importance. E.G. show the SF Giants at a higher level of complexity than the Dodgers.
Object type associated with the graphic. In a maritime navigation situation underwater obstructions would be more “important” than restaurants on land. This ordering of types may be modified by the user of the device.
Position of the device relative to the geo-located position of the graphic or object associated with the graphic, i.e. range from the device to the position of the object.
Danger or urgency level of object associated with graphic relative to the device, e.g. a freighter approaching at a constant bearing with closing range.
Velocity of the object associated with the graphic.
Velocity of an object associated with a graphic relative to the device.
Direction of motion of an object associated with graphic relative to the device.
Environmental conditions, e.g. temperature, tide height, wind speed, currants, wave heights, reduced visibility due to fog and/or rain. Increase IN for areas of inclement weather in area such as a squall that would be an object in itself.
Time of day. E.g. at night navigation markers have an increased importance to navigators.
Un-illuminated objects first. At night unlit obstructions such as submerged, unmarked rocks would have a higher IN than normally illuminated obstructions such as navigation markers.
Areas of interest. If an object is in a pre-defined area of interest then IN is altered. The change to the IN could be plus or minus.

### General Description of Graphics Controller System in Operation:

1) Graphics controller (GC) recalls all graphics primitives, as defined by application and/or user interaction, whose geo-located positions are within area of influence, the area of influence being defined in relation to unit position, and then determines which graphics are in unit field of view/address based upon unit attitude and attitude data. The GC may also determine what the probable future unit field of view/address will be.
2) Each graphic has an application defined base “importance number” (IN) assigned by the GC. For example, the application may define the area within 1 mile of Whale rock as very important and hence assign it a relatively high IN. Or the user may select a route consisting of a set of waypoints. As these waypoints come into the area of influence they are assigned a relatively high IN because the unit in that case gives priority to navigation markers. Graphics that are defined by application/user as very important or of major interest, such as danger areas, have a very high IN assigned.
3) If a Usage Profile (UP) is active GC increases IN of graphics defined as of interest by UP by an application defined percentage, 100% for example. Note that the increases may differ depending upon the type of object/area of interest.
4) System ascertains whether any graphics positions are within UP defined areas of interest, either user or system defined, their IN is increased by an application defined percentage.
5) A set of application defined IN reduction thresholds, 2 or 3D depending upon the application, centered on the unit position decrease the IN as the graphic becomes more distant from the unit position. E.g.
   0-500 m range=100% IN
   501-1000 m=80% IN
   1001-2000 m=60% IN etc.
6) A set of application defined IN reduction thresholds, 2 or 3D depending upon the application, decrease the IN of the graphic based upon its bearing off of the unit line of sight. E.g.
   0°-15° off unit line of sight=100% IN
   16°-30°=80% IN etc.
7) GC generates Graphics Hierarchy (GH), ordered from highest IN to lowest.
8) If reduction of graphics complexity due to unit vibration, slew rate or rate of change of position is indicated by the graphics limitation due to unit motion subsystem the GC reduces graphics complexity by number of levels so indicated.
9) If the active UP indicates modification of any graphics primitives, such as alternate default settings or a reduction in complexity level, the GC modifies the primitives so indicated.
10) GC calculates total of all graphics complexity numbers.
11) If CN total is larger than application allocated system resources are capable of the graphic complexity of the graphic with the lowest IN that is not at its lowest complexity level, is reduced by one level. (An application might demand very fast generation of graphics and limit the percentage of system resources available for image generation leaving more for data recall for example.)
12) GC loops through steps 11 & 12 until CN total is less than system resource limit (go to step 17) or all graphics are reduced to lowest complexity level.
13) GC calculates total of all graphics CNs
14) If all graphics are reduced to most basic complexity level and CN total still exceeds system resource limit then unit removes graphic with lowest IN from the GH and re-calculates CN total.
15) GC loops through steps 14 & 15 until CN total is less than system resource limit (go to step 17) or all graphics are deleted from GH.
16) GC informs user that it is incapable of displaying any of the requested graphics in real time mode and switches to snapshot mode.
17) GC transmits selected graphics primitives, and associated complexity levels, to rendering engine of device.
   An option upon start-up of the device may be to initially immediately generate objects within a defined IN threshold at the lowest CN, to ensure that they are instantly visible to the user, and to then go through the iterative process as described above to refine the graphics to be displayed.
   Also, an initial Graphics Complexity reduction, prior to activation of the GC system, could be performed automatically by the CPU based upon readings from sensors such as gyros indication a high vibration rate. For example, a table of CN reductions for each class of object for a given vibration rate could be used by the CPU to limit the CN's before the GC system begins its calculations thus saving time and power.

### Preferred Embodiment of Graphics Controller System in Operation

A vision system is used to illustrate the methods described in this disclosure. This vision system could be a traditional optical combiner type of instrument, such as a heads up display, or preferably a vision system of the type as disclosed in issued U.S. Pat. No. 5,815,411 entitled “Electro-Optic Vision Systems Which Exploit Position and Attitude” that includes internal positioning (GPS), attitude sensing (magnetic heading sensor) and vibration (accelerometers) devices. The disclosure of this vision system is incorporated herein by reference. It should be noted that the Importance Number (IN) system and/or the Graphics Complexity (GC) system could be entirely independent stand-alone systems in their own right with their own dedicated sensors. This disclosure is also used to illustrate concepts that relate to the development of user specific usage profiles, the reduction of graphics complexity due to detected unit motions, the recall and control of graphics primitives, and the allocation of system resources, among others.

### Graphics Limitation Due To Unit Motion Subsystem 108;

While motion of the device, specifically vibration rate and slew rate, is used in this preferred embodiment to illustrate the modification of the complexity to be generated other factors, as listed above in the section entitled “Complexity Number (CN)” may be utilized in other embodiments in much the same way as described.

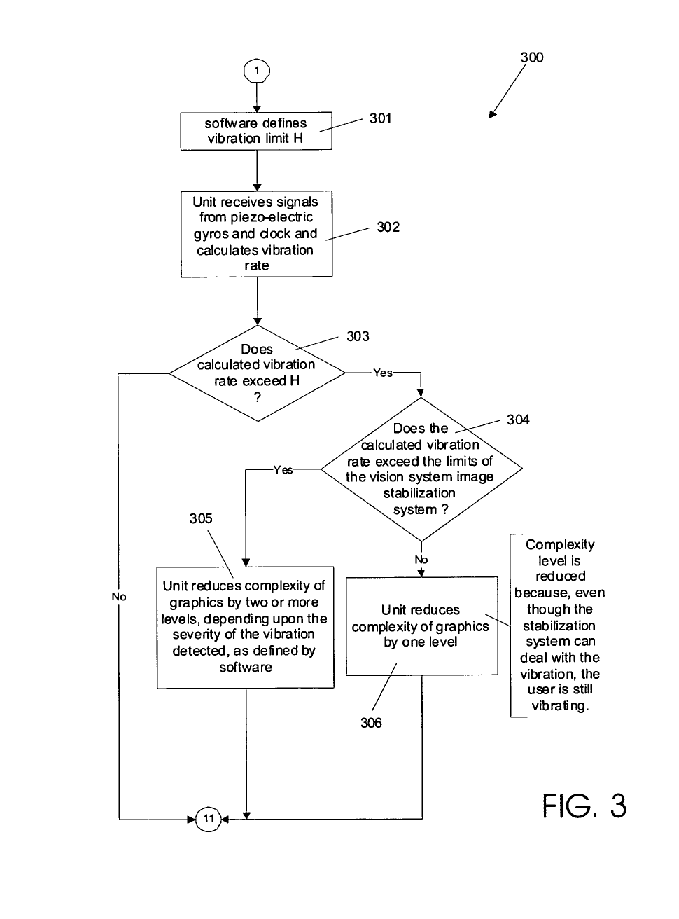

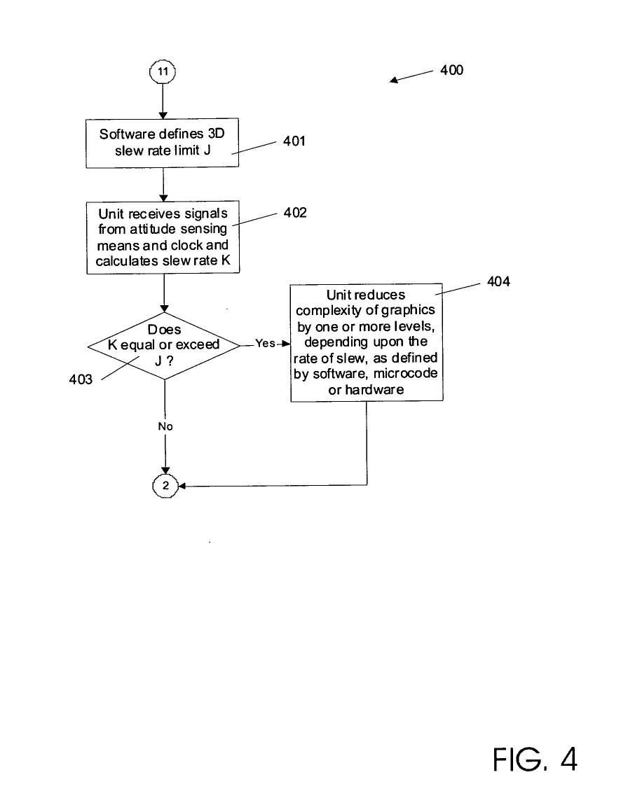

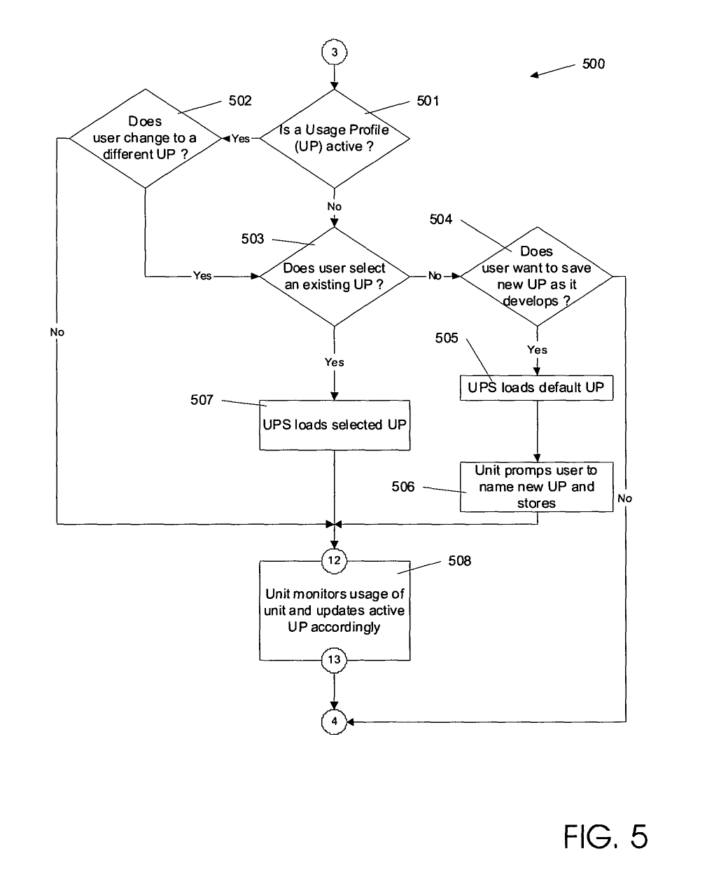

FIGS. 3 and 4 show the operation of the graphics limitation due to unit motion subsystem 108. Unit motion may include one or more of, a) vibration as detected by the accelerometers 106, b) slew rate (pitch, roll and yaw) as detected by the attitude sensor 105, typically a magnetic heading sensor, and/or the accelerometers 106, or c) rate of change of position as detected by the position sensor 104, typically a GPS. The methods for modifying the complexity levels of graphics to be generated based upon unit motions are very similar for each of the three sensors and vibration and slew rate are used here as exemplars. FIG. 3 is a flowchart 300 that shows how the graphics limitation due to unit motion subsystem 108 operates in relation to detected vision system 107 vibration. In step 301 the system defines the application specific vibration limit H. This limit is the level of vibration at which the vision system will begin to decrease the complexity of all graphics. In step 302 the system receives motion signals from the accelerometers 106 and time signals from the clock 101 and calculates the vibration rate. Accelerometers are also typically associated with the deformable prism image stabilization system of the vision system, though they may be independent of any other device system. In step 303 the system ascertains whether the calculated vibration rate exceeds H. If the calculated vibration rate does not exceed H the flowchart branches to step 401 of FIG. 4. If the calculated vibration rate does exceed H the flowchart branches to step 304. In step 304 the system ascertains whether the calculated vibration rate exceeds the ability of the vision system stabilization system to stabilize the image. If the calculated vibration rate does not exceed the ability of the vision system stabilization system to stabilize the image the flowchart branches to step 306. If the calculated vibration rate does exceed the ability of the vision system stabilization system to stabilize the image the flowchart branches to step 305. In step 306 the system reduces the complexity level of all graphics by one level. This is done because even though the vision system stabilization system can deal with the detected vibration the user will almost certainly be vibrating/moving also. In step 305 the system reduces the complexity level of all graphics by two or more levels, the amount being defined by application specific complexity reduction vibration thresholds. The flowchart then branches from both steps 305 and 306 to step 401 of FIG. 4. FIG. 4 is a flowchart 400 that shows how the graphics limitation due to unit motion subsystem 108 operates in relation to detected vision system 107 slew rate. In step 401 the system defines the application specific slew rate limit J. This limit is the slew rate at which the system will begin to reduce the complexity of all graphics. In step 402 the system receives signals from the attitude sensing device 105 and/or the accelerometers 106 and the clock 101 and calculates the slew rate K. In step 403 the system ascertains whether the calculated slew rate K exceeds J. If K does not exceed J the flowchart branches to step 501 of FIG. 5 and checks the usage profile subsystem 109. If K does exceed J the flowchart branches to step 404. In step 404 the system reduces the complexity level of all graphics by one or more levels, the amount being defined by application specific complexity reduction slew rate thresholds. The flowchart then branches to step 501 of FIG. 5 and checks the usage profile subsystem 109.

### Usage Profile Subsystem 109;

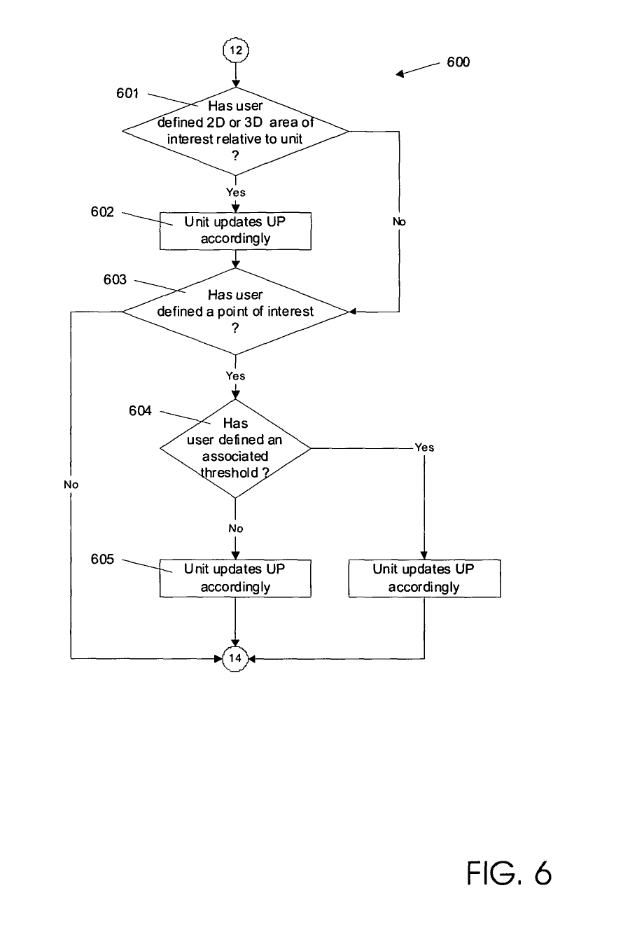

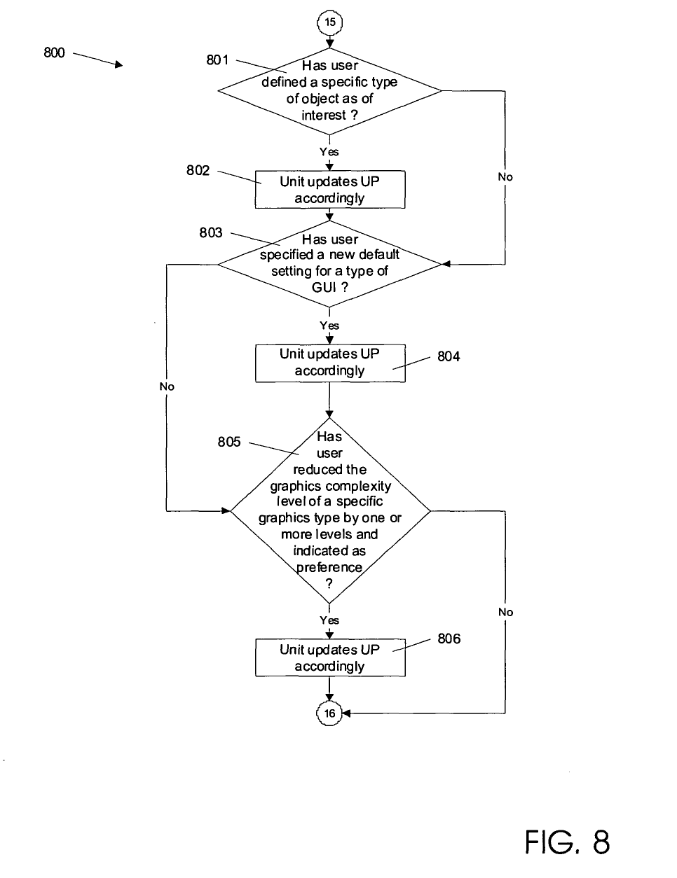

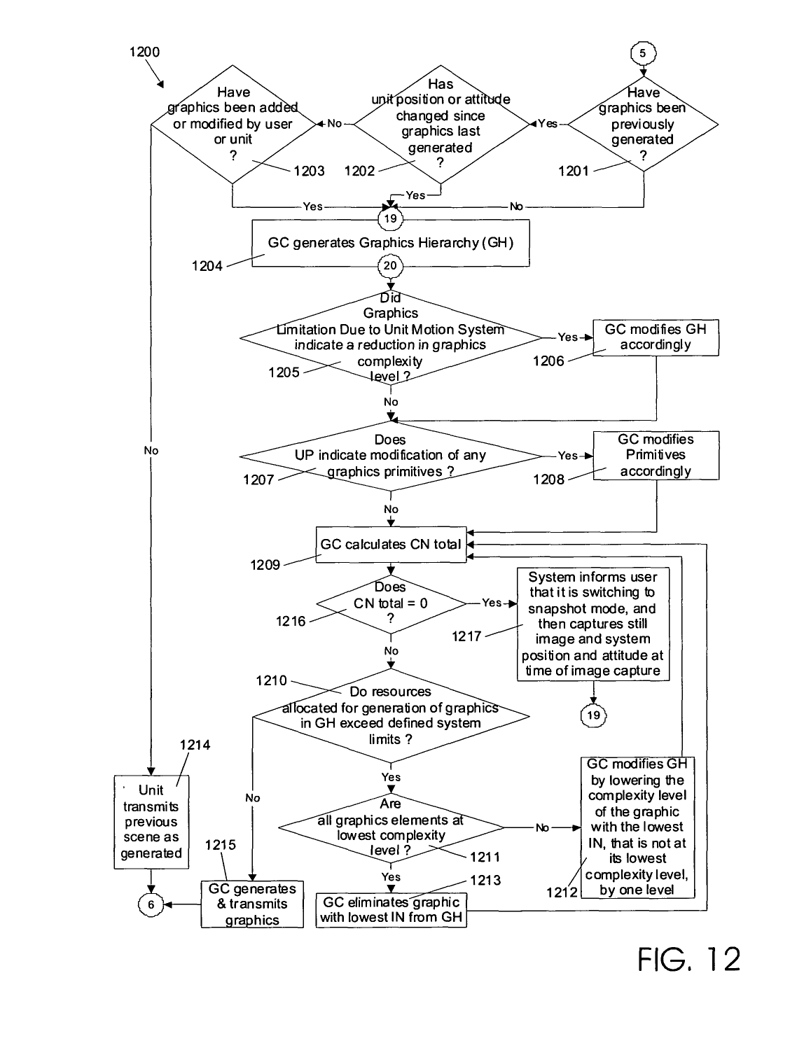

FIG. 5 is a flowchart 500 that shows the basic operation of the usage profile subsystem 109. In step 501 the system ascertains whether a usage profile (UP) is active. If a UP is active the flowchart branches to step 502. If a UP is not active the flowchart branches to step 503. In step 502 the system ascertains whether the user has changed to a different UP. If the user has not changed UPs' the flowchart branches to step 508. If the user has changed UPs' the flowchart branches to step 503. In step 503 the system ascertains whether the user has selected an existing UP. If the user has recalled an existing UP the flowchart branches to step 507, in which the usage profile subsystem 109 loads the selected UP, and then branches to step 508. If the user has not selected an existing UP the flowchart branches to step 504 in which the system queries the user as to the desire to save the new “virgin” UP as it develops. If the user does desire to save the new UP as it develops the flowchart branches to step 505, in which the usage profile subsystem 109 loads a default UP, and then branches to step 506, in which the system prompts the user to name the new UP and stores as such (if user does not name UP the system may assign it a default name), and then branches to step 508. The default UP may be pre-defined by the application to include a basic set of parameters or may be a blank slate. If the user does not desire to save the new UP as it develops the flowchart branches to step 1201 of FIG. 12, the start of the graphics controller subsystem flowchart 1200. In step 508 the system monitors the system usage and updates the active UP as accordingly. Step 508 is expanded in FIGS. 6-11.

FIGS. 6-11 are flowcharts 600, 700, 800, 900, 1000 and 1100 that show the operation of step 508 of flowchart 500. In step 601 the system ascertains whether the user has defined a 2D or 3D area of interest relative to the system position. In other words, has the user defined an area that is always in the same position relative to the unit as of interest. An example of such an area would be a guard zone ring with the system at its center. If the user has defined a 2D or 3D area of interest relative to the unit the flowchart branches to step 602, in which the system adds this area of interest to the active UP, and then branches to step 603. If the user has not defined a 2D or 3D area of interest relative to the unit the flowchart branches to step 603. In step 603 the system ascertains whether the user has defined a point of interest. This point would have a real world position and would not be fixed relative to the unit position. If the user has not defined a point of interest the flowchart branches to step 701. If the user has indicated a point of interest the flowchart branches to step 604, in which the system ascertains whether the user has defined an associated threshold for the point of interest. This threshold will define an area relative to the point that is also of interest. An example would be defining whale rock as of interest and associating a threshold of 500 m with whale rock user is indicating that they are interested in whale rock and all objects within 500 m of it. If the user has not defined an associated threshold the flowchart branches to step 605 in which the system updates the active UP accordingly, and then branches to step 701. If the user had defined an associated threshold the flowchart branches to step 605, in which the system updates the active UP accordingly, and then branches to step 701.

In step 701 the system ascertains whether the user has defined a line/route of interest such as an intended track. A line may be straight or curved and a route is defined as being made up of several line segments connected end to end. If the user has not defined a line/route of interest the flowchart branches to step 704. If the user has defined a line/route of interest the flowchart branches to step 702, in which the system ascertains whether the user has defined an associated threshold for the line/route of interest. This threshold will define an area relative to the line/route that is also of interest. An example would be by defining a route from Auckland to the Bay of Islands, in New Zealand, as of interest and defining an associated threshold of 200 m to indicate that the user is interested in all objects, both static and moving, within 200 m of the defined route. If the user has not defined an associated threshold the flowchart branches to step 703 in which the system updates the active UP accordingly, and then branches to step 704. If the user has defined an associated threshold the flowchart branches to step 703, in which the system updates the active UP accordingly, and then branches to step 704. In step 704 the system ascertains whether the user has defined a 2D or 3D area of interest. If the user has not defined a 2D or 3D area of interest the flowchart branches to step 801. If the user has defined a 2D or 3D area of interest the flowchart branches to step 705, in which the system ascertained whether the user has defined an associated range threshold. If the user has not defined an associated threshold the flowchart branches to step 706 in which the system updates the UP accordingly, and then branches to step 801. If the user has defined an associated threshold the flowchart branches to step 706, in which the system updates the active UP accordingly, and then branches to step 801.

In step 801 the system ascertains whether the user has defined a specific type of graphics object as of interest. If the user has defined a specific type of graphic as of interest the flowchart branches to step 802, in which the system updates the active UP accordingly, and then branches to step 803. If the user has not defined a specific graphic type as of interest the flowchart branches to step 803. In step 803 the system ascertains whether the user has specified a new default setting for a type of graphic user interface (GUI). This allows the user to alter the default setting of a type of GUI and have that setting become part of that users UP. In future that setting will be used as the default setting for that type of GUI for that user. In other words the user modifies the GUI once, saves as new default, and the system brings all GUIs of that type up in that configuration automatically. If the user has altered the default settings of a GUI the flowchart branches to step 804, in which the UP is updated accordingly, and then branches to step 805. If the user has not altered the default setting of a type of GUI the flowchart branches to step 805. In step 805 the system ascertains whether the user has reduced the complexity level of a specific type of graphic by one or more levels and indicated this reduction as a preference. If the user has reduced the complexity level of a specific type of graphic and indicated this as preference the flowchart branches to step 806, where that system updates the active UP accordingly, and then branches to step 901. If the user has not reduced the complexity level of a specific type of graphic and indicated this as preference the flowchart branches to step 901.

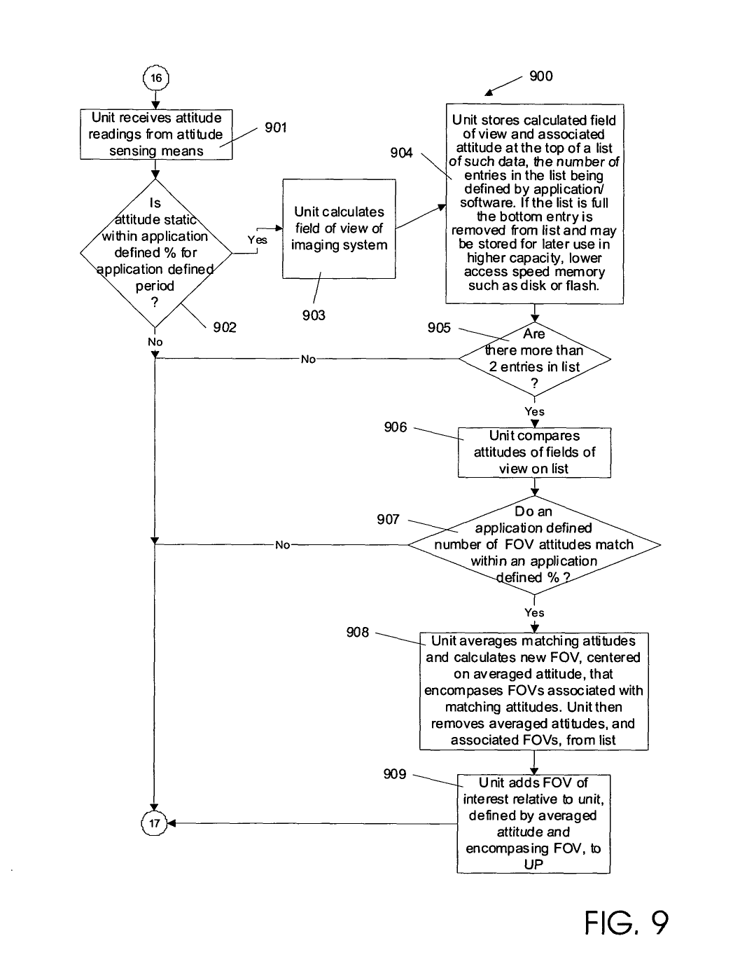

FIG. 9 is a flowchart 900 that shows how the system generates areas of interest relative to the unit by monitoring the attitude readings of the system. These areas are not defined by the user. In step 901 the usage profile subsystem 109 receives attitude readings from the attitude sensing device 105. In step 902 the system ascertains whether the system attitude has been static, i.e. unchanged, within an application defined tolerance for an application defined period of time. If the system attitude has not been static the flowchart branches to step 1001. If the system attitude has been static the flowchart branches to step 903, in which the system calculates the vision system 107 field of view, and than branches to step 904. In step 904 the system stores the calculated field of view and associated attitude reading at the top of a list of such data. The number of entries in this list are defined by application. If the list is full the bottom entry is removed from list and may be stored for later use in higher capacity, lower speed memory such as disk or Flash which may be external to the device. The flowchart then branches to step 905 in which the system ascertains whether there are more than two entries in the list. If there are not more two entries in the list the flowchart branches to step 1001. If there are more than two entries in the list the flowchart branches to step 906, in which the system compares the attitude readings of the list entries, and then branches to step 907. In step 907 the system ascertains whether any of the entries attitude readings match within an application defined tolerance. If some or all of the attitude readings do not match the system branches to step 1001. If some or all of the attitude readings do match the system branches to step 908. In step 908 the system averages the matching attitude readings and calculates a field of view (FOV), centered on the average attitude, that will encompass all the fields of view associated with the averaged attitude readings. The system then removes the averaged attitude readings and associated FOVs from the list of such data. The flowchart then branches to step 909 in which the system adds the newly calculated FOV of interest relative to the unit to the active UP. The flowchart then branches to step 1001.

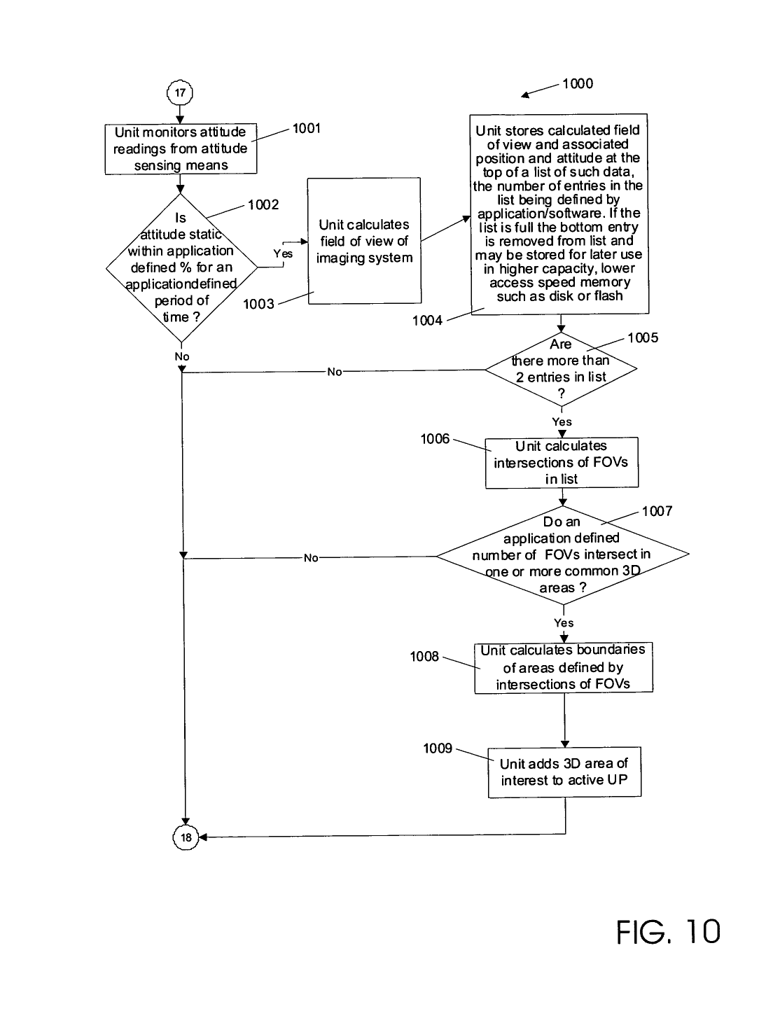

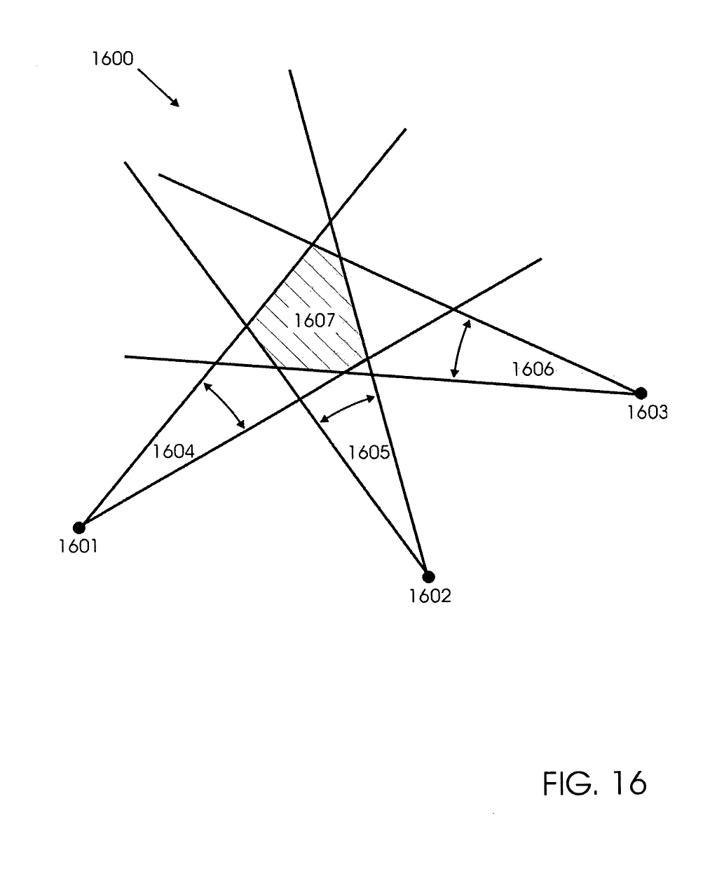

FIG. 10 is a flowchart 1000 that shows how the system generates areas of interest that are not relative to the unit by monitoring the attitude and position readings of the system. These areas will have static real world positions and are not defined by the user. In step 1001 the usage profile subsystem 109 receives attitude readings from the attitude sensing device 105 and position readings from the position sensing device 304. In step 1002 the system ascertains whether the system attitude has been static, i.e. unchanged, within an application defined tolerance for an application defined period of time. If the system attitude has not been static the flowchart branches to step 1101. If the system attitude has been static the flowchart branches to step 1003, in which the system calculates the vision system 107 field of view (FOV), and than branches to step 1004. In step 1004 the system stores the calculated FOV and associated position and attitude readings at the top of a list of such data. The number of entries in this list are defined by application. If the list is full the bottom entry is removed from list and may be stored for later use in higher capacity, lower speed memory such as disk or Flash which may be external to the device. The flowchart then branches to step 1005 in which the system ascertains whether there are more than two entries in the list. If there are not more two entries in the list the flowchart branches to step 1101. If there are more than two entries in the list the flowchart branches to step 1006, in which the system calculates the intersections of the FOVs on the list, and then branches to step 1007. In step 1007 the system ascertains whether an application defined number of the FOVs intersect in a common 3D area. FIG. 16 shows, in plan view, the intersection 1607 of 3 fields of view 1604, 1605, 1606, each from a different position 1601, 1602, 1603. The shaded area is the area of common intersection. Note that there may be more than one area of common intersection in step 1007. If the system ascertains that sufficient listed FOVs do not intersect in a common area the flowchart branches to step 1101. If the system ascertains that sufficient listed FOVs do intersect in a common area the flowchart branches to step 1008, in which the boundaries of the areas of common intersection are calculated by the unit, and then to step 1009, in which the calculated common areas of intersection are added to the active UP as 3D areas of interest. The flowchart then branches to step 1101.

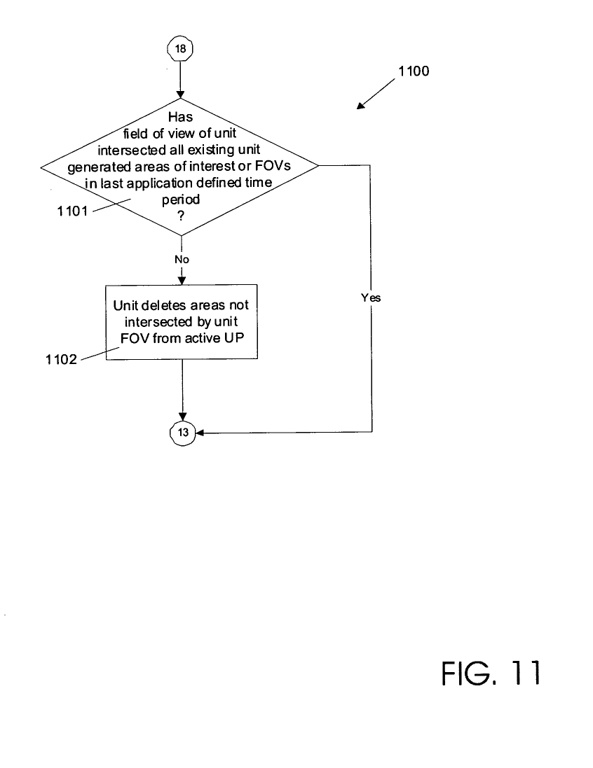

FIG. 11 is a flowchart 1100 that shows how the system would remove system generated areas of interest or system generated relative FOVs of interest, those generated as shown in FIGS. 9 and 10, from the active UP. In step 1101 the system ascertains whether the field of view of the vision system 107 has intersected all system defined areas of interest and all system defined FOVs of interest within an application defined time period. If all such areas have been intersected by the vision system 107 field of view within the defined time period the flowchart branches to step 1201, the start of the graphics controller subsystem flowchart 1200. If all such areas have not been intersected by the vision system 107 field of view within the defined time period the flowchart branches to step 1102, in which the areas or FOVs not intersected are removed from the active UP, and then branches to step 1201, the start of the graphics controller subsystem flowchart 1200.

### Graphics Controller Subsystem 110;

The graphics controller subsystem 110 controls how the system recalls graphics primitives, and at what complexity level each graphic is generated. Each graphic primitive consists of 1) a position that defines the location of the graphic in relation to an arbitrary reference coordinate system, 2) an attitude that defines the orientation of the graphic in relation to an arbitrary reference coordinate system, and 3) a model and complexity number (CN) for each graphics complexity level. The model is sufficient to define the shape, scale and content of the graphic. Note that the graphic may be 2D or 3D, as defined by the model, and may even be an animation. Each graphic may have many graphic complexity levels associated with it. These would range from highly complex, a full blown raster image for example, to the minimum complexity required to impart the meaning of the graphic, a simple vector image or icon associated with that object type for example. Note that some images may only have one complexity level while others might have many. The complexity number associated with each graphics complexity level defines the number of calculations required to generate the graphic at that level. These different complexity levels are used by the graphics controller subsystem 110 when allocating system resources for graphics generation as described below.

Each graphic is assigned an importance number (IN), the IN being application defined. For example, in a maritime navigation application the graphics associated with navigation markers would have a relatively high IN but in a tourism application covering the same area the navigation markers are of lesser importance and therefore the graphics associated with them have a lower IN. Note that the IN's assigned by an application could change as an application switched from one mode of operation to another. Using the above example, the application could be for that region with two modes of operation, navigation and tourism. The IN is used by the graphics controller subsystem 110 when allocating system resources for graphics generation as described below.

An area of influence, relative to unit position or having a real world position, may be defined by software/application/microcode/hardware/user. This area of influence may be a two or three dimensional shape, a circle or a sphere for example. Note that area of influence need not be symmetrical or centered on unit position. An area of influence might be, for example, the visible horizon. The area of influence defines the area in which graphics primitive positions must be to be recalled by the graphics controller subsystem 110.

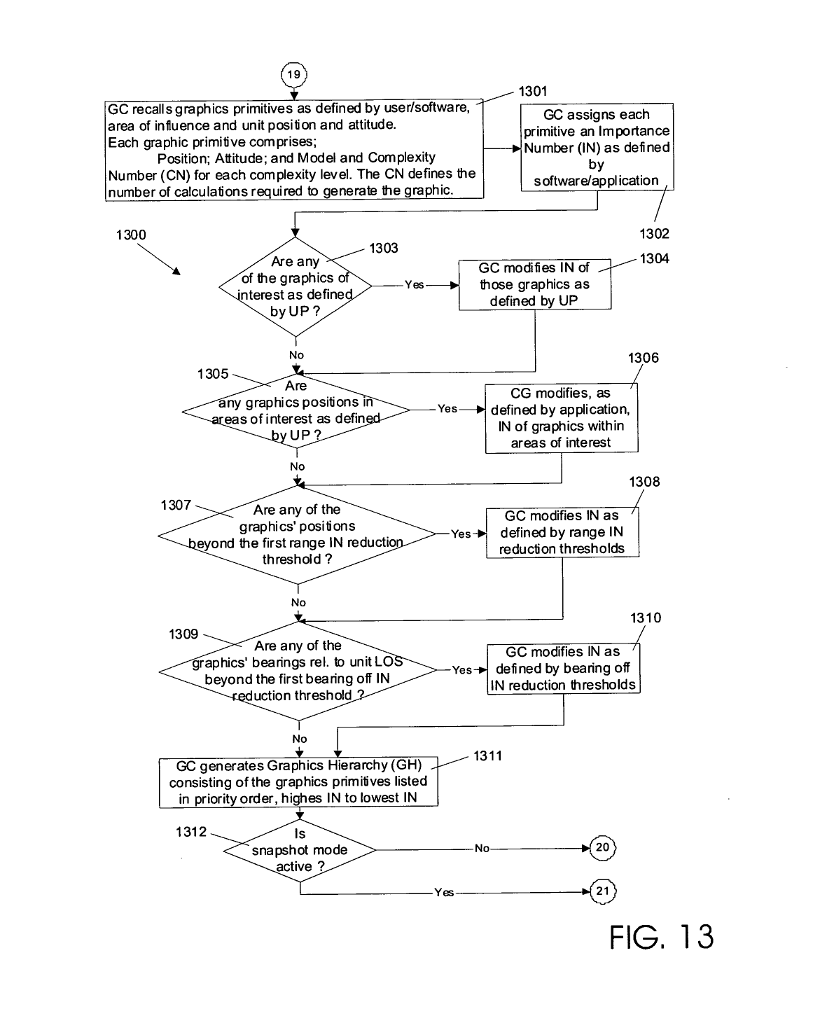

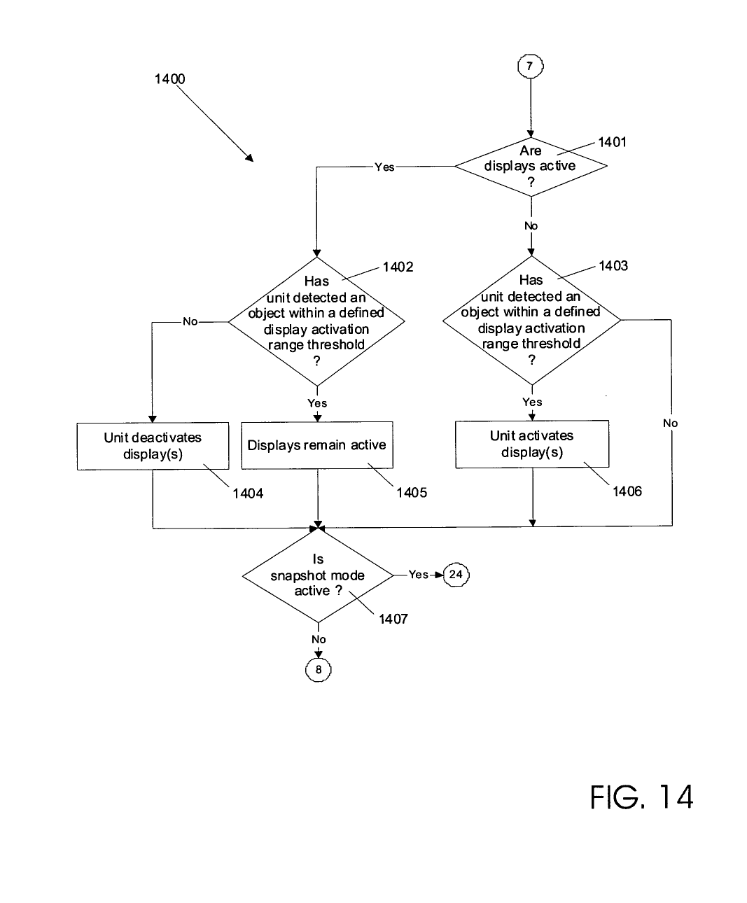

FIG. 12 is a flowchart 1200 that shows the operation of the graphics controller (GC) subsystem 110. In step 1201 the system ascertains whether the vision system has previously generated graphics. If graphics have not been generated the flowchart branches to step 1204. If graphics have been generated the flowchart branches to step 1202, in which the system ascertains whether the vision system position or attitude have changed since the graphics were generated. If the position or attitude have changed the flowchart branches to step 1204. If the position or attitude have not changed the flowchart branches to step 1203, in which the system ascertains whether the user, or the vision system itself, have added to or modified the graphics. If the graphics have not been modified or added to the flowchart branches to step 1214, in which the previously generated graphics are transmitted to the display of the vision system 107, and then branches to step 1401 of FIG. 14 to check the display usage subsystem 111. If the graphics have been modified or added to the flowchart branches to step 1204. In step 1204 the GC generates the graphics hierarchy (GH) as shown in FIG. 13, and the flowchart then branches to step 1205. In step 1205 the GC ascertains whether the graphics limitation due to unit motion subsystem 108 has indicated a reduction in the graphics complexity level as a whole. If such a reduction is indicated the flowchart branches to step 1206, in which the GC modifies the GH accordingly, and then branches to step 1207. If such a reduction is not indicated the flowchart branches to step 1207. In step 1207 the GC ascertains whether the active UP indicates modification, such as alternate default settings or a reduction in complexity level, of any graphics primitives in the GH. If such a modification is indicated the flowchart branches to step 1208, in which the GC modifies the GH accordingly, and then branches to step 1209. If such a modification is not indicated the flowchart branches to step 1209. In step 1209 the GC calculates the total off all complexity numbers for the graphics primitives in the GH at their present complexity levels and the flowchart then branches to step 1216 in which the system checks to see if the CN total equals zero. If the CN total does equal zero, in other words all graphics primitives have been removed from the graphics hierarchy, due to excessive motion for example, the flowchart branches to step 1217, in which the system informs the user that it is switching to snapshot mode and captures a still image and the system position and attitude at the time of image capture, and then branches to step 1301 of FIG. 13 to generate a new GH. If the CN total does not equal zero the flowchart branches to step 1210 in which the system ascertains whether the resources required to generate all the graphics in the GH at their present complexity levels exceeds the available system resources. The resources available for graphics generation may be contingent upon processor speed, available memory, battery state/available power, power usage, data transmission speed, pre-defined graphics and pre-loaded icon sets, etc. If the resources required do exceed the allocated system resources the flowchart branches to step 1211. If the resources required do not exceed the allocated system resources the flowchart branches to step 1215, in which the GC generates the graphics, and then branches to step 1401 of FIG. 14 to check the display usage subsystem 111. In step 1211 the GC ascertains whether all the graphics primitives in the GH are at their lowest complexity level setting. If all the graphics primitives in the GH are not at their lowest complexity level the flowchart branches to step 1212, in which the GC modifies the GH by reducing the complexity level, and hence the CN, of the primitive with the lowest IN that is not already at its lowest complexity level by one level, and then branches to step 1209 to calculate the CN total once more. If all the graphics primitives in the GH are at their lowest complexity level the flowchart branches to step 1213, in which the GC eliminates the primitive with the lowest IN from the GH, and then branches to step 1209 to calculate the CN total once more.

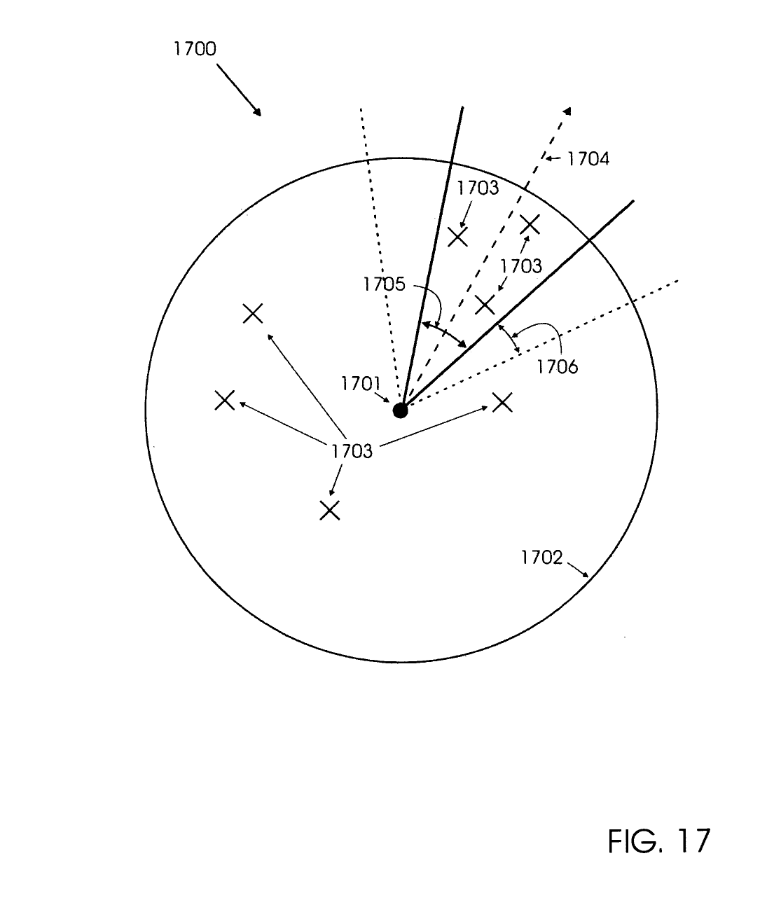

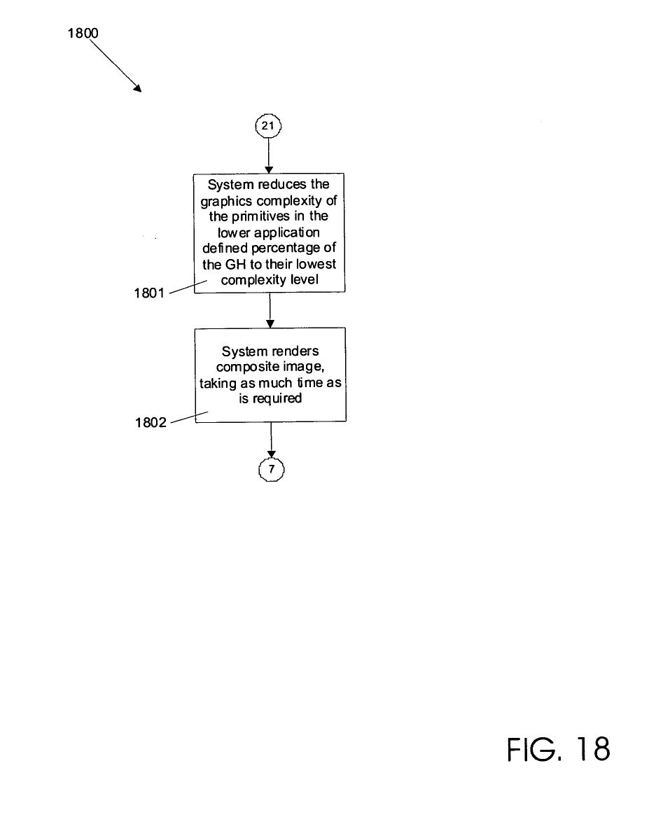

FIG. 13 is a flowchart that shows how the GC generates the graphics hierarchy (GH). In step 1301 the GC recalls all graphics primitives, as defined by application and user interaction, whose position is within the area of influence, the area of influence being application or user defined in relation to system position, and then determines which graphics are within the vision system 107 field of view based upon system attitude and field of view data. FIG. 17 shows a plan view of the location 1701 of vision system 107, the limit of a defined area of influence 1702, positions of graphics primitives 1703, the line of sight 1704 and field of view/address 1705 of the vision system 107. Note that if the device was not a vision system, a cell phone for example, it still may have a field of address similar to the field of view of a vision system. This field of address may be a cone of 30 degrees spread with it's axis that of the cell phone's longest dimension for example. FIG. 17 also shows a “display buffer” zone 1706 in which graphics primitives that have just left or may soon be in the field of view 1705 are tracked. The flowchart then branches to step 1302, in which each graphic has an application defined base “importance number” (IN) assigned it by the GC. For example, the application may define the area within 1 mile of Whale rock as very important and hence assign it a relatively high IN. Or the user may select a route consisting of a set of waypoints. As these waypoints come into the area of influence they are assigned a relatively high IN because the unit gives priority to navigation markers. Graphics that are defined by application/user as very important or of major interest, such as danger areas, have a very high IN assigned. The flowchart then branches to step 1303, in which the GC ascertains whether any of the recalled graphics have been defined as of interest by the active UP. If graphics have been defined as of interest the flowchart branches to step 1304, in which the IN of those graphics is increased by an application defined percentage, and then branches to step 1305. If graphics have not been defined as of interest the flowchart branches to step 1305. In step 1305 the GC ascertains whether any of the graphics' positions are within areas of interest, either user or system defined. If any graphics' positions are within areas interest the flowchart branches to step 1306, in which the GC increases the IN of the graphics in the areas of interest by an application defined percentage, and then branches to step 1307. If any graphics' positions are not within areas interest the flowchart branches to step 1307. In step 1307 the GC ascertains whether the range to any graphics positions exceeds the first range IN reduction threshold. An example of such a threshold system would be 0-500 m=100% IN, 501-1000 m=80% IN, 1001-1500 m=60% IN etc. If the range to any graphics positions does exceed the first range IN reduction threshold the flowchart branches to step 1308, in which the IN of those graphics is reduced according to the application set range IN reduction thresholds, and then branches to step 1309. If the range to any graphics positions does not exceed the first IN reduction threshold the flowchart branches to step 1309. In step 1309 the GC ascertains whether the bearing off from the vision system 107 line of sight to any graphics exceeds the first bearing IN reduction threshold. If the bearing to any graphics positions does exceed the first bearing IN reduction threshold the flowchart branches to step 1310, in which the IN of those graphics is reduced according to the application set bearing IN reduction thresholds, and then branches to step 1311. If the bearing to any graphics positions does not exceed the first bearing IN reduction threshold the flowchart branches to step 1311. In step 1311 the GC generates a graphics hierarchy (GH) that consists of the graphics primitives listed in priority order, highest IN to lowest and then the flowchart branches to step 1312. In step 1312 the system ascertains whether snapshot mode is active. If snapshot mode is active the flowchart branches to step 1801 of FIG. 18. If snapshot mode is not active the flowchart branches to 1205 of FIG. 12.

### Snapshot Mode:

Snapshot mode allows the system to still display information to the user if conditions, such as excessive device motion, do not allow real time generation of the imagery. This is done by capturing a still image and associated position and attitude, generating a graphics hierarchy, reducing the complexity levels of a set percentage of the lowest primitives in the GH, and generating a composite image. The composite image generation may take more time than is normally allowed for image generation in real time operation. This mode is typically activated automatically as is shown in steps 1216 and 1217 of FIG. 12 but may also be activated by the user upon request.

FIG. 18 is a flowchart 1800 that shows part of the operation of the vision system 107 in snapshot mode. In step 1801 the system reduces the graphics complexity of primitives in the lower percentage of the GH to their lowest levels. This percentage, 80% for example, would be defined by the application. This is done to speed up the generation of the composite image by generating only those graphics that are of greatest importance, according to the GH, are generated at their maximum complexity level. The flowchart then branches to step 1802, in which the system renders the composite image taking as much time as is required because the frame is not required within a “real time” time frame, and then branches to step 1401 of FIG. 14 to check the display usage subsystem 111.

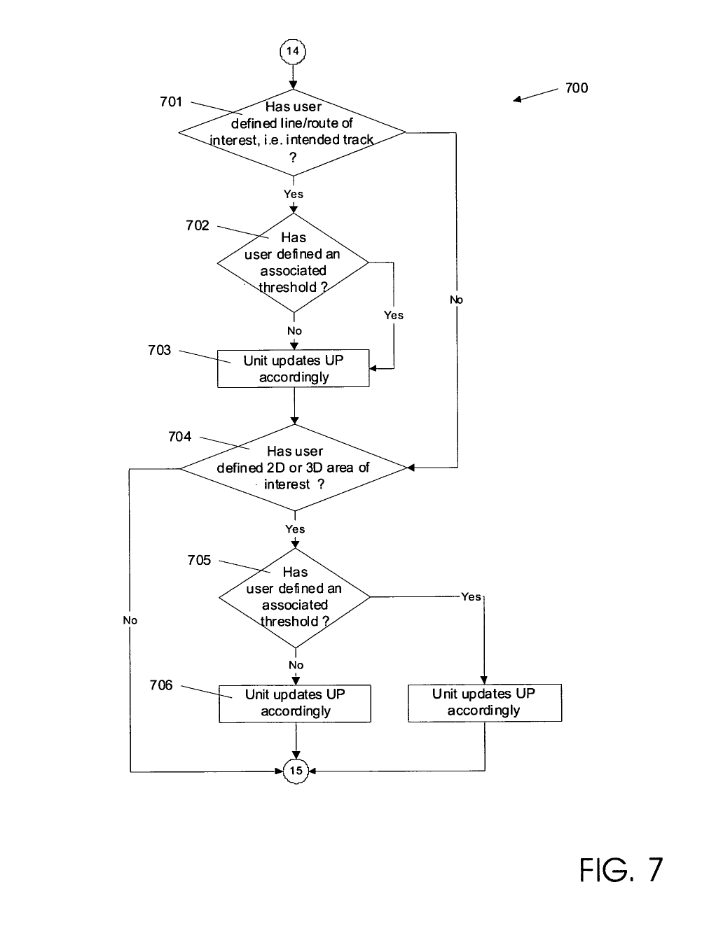

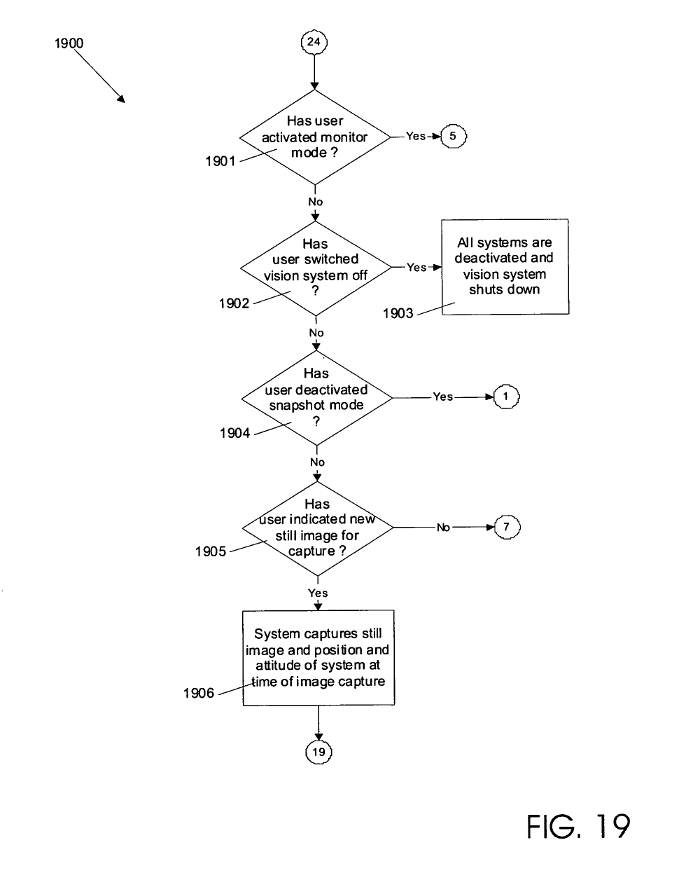

FIG. 19 is a flowchart 1900 that shows additional operation of the vision system 107 in snapshot mode. In step 1901 the system ascertains whether the user has activated monitor mode. If monitor mode has been activated the flowchart branches to step 702 of FIG. 7 to begin monitoring the time trigger 206. If monitor mode has not been activated the flowchart branches to step 1302 in which the system ascertains whether the vision system 107 as a whole has been turned off. If the vision system 107 has been turned off the flowchart branches to step 1903 in which all systems are deactivated and the vision system 107 shuts down. If the vision system has not been turned off the flowchart branches to step 1904 in which the system ascertains whether the user has deactivated snapshot mode. If snapshot mode has been deactivated the flowchart branches to step 702 of FIG. 7 to check the graphics limitation due to unit motion subsystem 108. If snapshot mode has not been deactivated the flowchart branches to step 1905 in which the system ascertains whether the user has indicated a new still image for capture. If a new image has been indicated the flowchart branches to step 1906, in which the system capture the new still image and the system position and attitude at the time of image capture, and then branches to step 1301 of FIG. 13 to generate a new GH. If a new image has not been indicated the flowchart branches to step 1401 of FIG. 14 to check the display usage subsystem 111.

### Display Usage Subsystem 111;

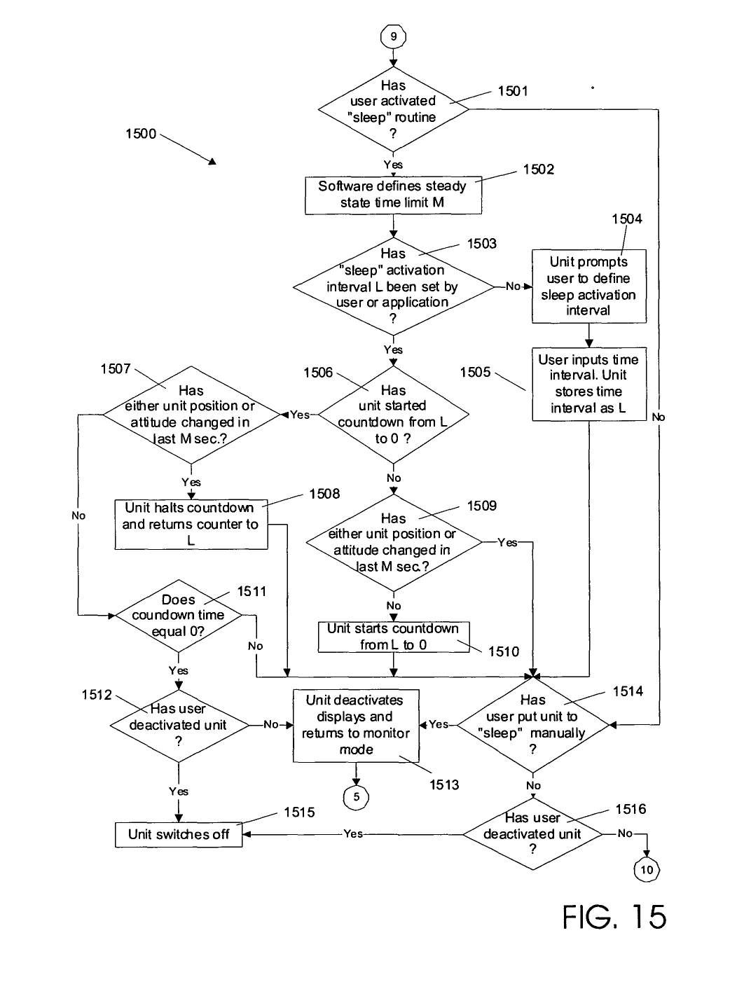

FIG. 14 is a flowchart 1400 showing the operation of the display usage subsystem 111. This subsystem is operable for detecting whether the user is actually looking at the display(s) of the vision system and activating or deactivating the display(s) accordingly. Note that some of the activities, such as warming up the screen backlighting, might not be deactivated at all, instead remaining active while the vision system as a whole is fully activated. In step 1401 the system ascertains whether the display(s) is/are active. If the display(s) is/are active the flowchart branches to step 1402. If the display(s) is/are not active the flowchart branches to step 1403. In step 1402 the system ascertains whether an object is within the application/user defined display activation range threshold. This may be done by the use of a low power sonic, light emitting, laser or other similar ranging device. The user may want to modify this activation threshold, for example to allow wearers of corrective lenses or sunglasses to use the subsystem and still be able to activate the displays. This could be taken one step further in that the preferred display activation range threshold could be part of that users usage profile. If an object is detected within the display activation range threshold the flowchart branches to step 1405 in which the displays remain activated and then branches to 1407. If an object is not detected within the display activation range threshold the flowchart branches to step 1404 in which the displays are deactivated and then branches to step 1407. In step 1403 the system ascertains whether an object is within the application/user defined display activation range threshold. If an object is detected within the display activation range threshold the flowchart branches to step 1406 in which the displays are activated and then branches to step 1407. If an object is not detected within the display activation range threshold the flowchart branches to step 1407. In step 1407 the system ascertains whether snapshot mode is active. If snapshot mode is active the flowchart branches to step 1901 of FIG. 19. If snapshot mode is not active the flowchart branches to step 1501 of FIG. 15 to check the sleep subsystem 112.

### Sleep Subsystem 112;

FIG. 15 is a flowchart 1500 that shows the operation of the sleep subsystem 112.

This subsystem is enabled for returning the system to monitor mode if the vision systems position or attitude do not change over a user or application defined period of time.

Also, the initial Graphics Complexity reduction could be performed by the CPU or application processor based upon readings from sensors such as accelerometers indication a high vibration rate. For example, a table of CN reductions for each class of object for a given vibration rate could be used by the CPU to limit the CN's before the GC system begins its calculations thus saving time and power.

The detected accelerations of a device may also be used to refine the determined direction of the bore-site of a device such as a vision system by monitoring the accelerations of a device in the vertical plane and compensating based upon a pre-set set of rules which may be defined by location, application, user, etc. An example would be a vision system being used in a vehicle that is off road. The vertical accelerations in the upward direction are likely to be far more sudden than those in the downward direction given the normal action of a vehicles suspension and therefore the system would only read in a percentage of the upward motion when determining the averaged, stabilized bore site of the device.

The examples above are directed to specific embodiments which illustrate preferred versions of devices and methods of these inventions. In the interests of completeness, a more general description of devices and the elements of which they are comprised as well as methods and the steps of which they are comprised is presented herefollowing.

One will now fully appreciate how a graphic system may be formed to generate graphical elements of a compound image with a preference for the importance and complexity of the graphic in view of the instantaneous state of a handheld system associated with the image being generated. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1. Methods of rendering graphical images, the methods being responsive to physical states of a freely movable mobile unit including those determined by an inertial measurement unit.

2. Methods of claim 1, the methods being responsive to position and pointing direction of said freely movable mobile unit.

3. Methods of claim 1, further comprising the steps:
determining a position of a mobile device,
determining a pointing attitude of the mobile device,
generating an image including a plurality of graphical elements whereby the order and detail of said graphical elements is rendered with dependence upon values measured as position and attitude.
